(19) United States
(12) Patent Application Publication
(10) Pub. No.: US 2013/0095201 A1
(43) Pub. Date: Apr. 18, 2013

(54) DECORATIVE AND STIFFENED MOLD FOR CUPCAKES, MUFFINS AND MOLDABLE FOOD

(71) Applicants: Edward J. BLOOM, Rumson, NJ (US); Stuart Harvey LEE, Forest Hills, NY (US); Jenna Marie EDGEMON, Brooklyn, NY (US)

(72) Inventors: Edward J. BLOOM, Rumson, NJ (US); Stuart Harvey LEE, Forest Hills, NY (US); Jenna Marie EDGEMON, Brooklyn, NY (US)

(73) Assignee: HEAD CHEFS LLC, Iselin, NJ (US)

(21) Appl. No.: 13/274,993

(22) Filed: Oct. 17, 2011

(51) Int. Cl. B28B 13/02

(52) U.S. Cl. 425/447

(57) ABSTRACT

A mold for a cupcake, muffin, moldable food, or the like having a cup with an open end surrounded by a decorative peripheral border that is representational of the periphery of a head or face of a person or animal. The border is wider than the cup at the open end and stiffens the mold. The border invites a person to decorate the batter or foodstuff in the mold with representations of facial features.

### BACKGROUND OF THE INVENTION

The invention herein disclosed concerns a cupcake or muffin mold, also useful for chilled, gelatinous or other moldable food, and particularly concerns a decorative peripheral border extending around the periphery of the mold and additionally serving to stiffen the mold around the opening.

When this specification refers only to a cupcake, the disclosure applies to a muffin and anything else that may be baked in a cupcake or muffin mold and also applies to any moldable food, e.g. gelatin desserts, that may be held in a mold for a purpose of baking, cooking, chilling, freezing, etc.

A mold for a cupcake, muffin or other moldable food includes a receptacle for the cupcake batter to be baked or the food to be molded. The receptacle is cup shaped and has an open end with a periphery. The batter or foodstuff is placed in the cup through the open end. After the cupcake or muffin is baked or the moldable food has been prepared, it is removed from the cup through the open end.

It is known to provide decoration on the exterior of a cupcake mold to make the mold attractive for purchase and use. Typically, the decoration is not also functional in the mold in some manner. Examples of ornamentation of cupcake molds appear in prior art. The ornamentation may provide a support for the mold, as in Patent D 552,409. It may be attached to the mold, as in Patent D 578,338. More relevant prior art for the present invention includes decorative or functional parts that are attached at the periphery of the opening. For example, in Patent D 628,446, the decoration is representational of legs, e.g. of an insect, and the opening in the mold defines the body of the insect. In Patent D 578,337, the mold is representational of the body of an animal, e.g. a bear, and elements of the bear anatomy are attached at locations around the opening in the mold, e.g. the head and neck at one side, the arms at the lateral sides and legs at the side opposite the head. In none of the art seen by Applicant is the decoration around the mold opening representational of a head or a face of an object. In none of the prior art is the periphery of the head or face completely surrounded by the decoration which wraps entirely around the opening, so that an entire representational head or face includes the opening into the cup and the decoration surrounding the opening. In none of the prior art is the decorative peripheral border around the cup opening also a stiffening of the area of the mold around the opening which stiffens and maintains the shape of the cup and its opening.

### SUMMARY OF THE INVENTION

The invention concerns an individual cupcake or muffin mold or mold for a moldable food having the entire periphery of its open end surrounded by a decorative peripheral border that gives the mold the appearance of a head or face and the decorative peripheral border completely surrounding the open end of the mold is also the peripheral part of the head or face, such that the decoration is not placed only at spaced apart locations around the open end. The radial width of the decoration around the open end is greater than the radial width of the cup, such that the additional material of the peripheral border provides additional support and stiffening for the open end and helps it maintain its shape. Particularly when the mold cup and its open end are made of a flexible material, which aids in the release of a baked cupcake or muffin from the mold, this stiffening is of assistance to maintain the shape of the mold which is deformed when the baked cupcake is removed.

In the preferred form, the entire cupcake mold including the decorative peripheral border is made of a material which releases a baked cupcake or muffin or other food from the mold. The material of the mold, including the peripheral border may be of paper, metal, release agent, like Teflon™ (polyurethane) abated metal, plastic, rubber, etc. In a more preferred form, the mold and its decorative peripheral border are made from flexible, silicone rubber which is a release material that may be molded to the designed shape, which can withstand the heat of baking, the chill of freezing, the process of cleaning for reuse and is deformable so that the material in the mold and the baked cupcake, et al easily separate from the mold. Further, silicone rubber is capable of being produced in any color, so that the decoration of the head or face around the mold can be of a selected color or a color consistent with the nature of the decoration, as described further below.

It is the principal object of the present invention to provide a cupcake or muffin mold which is representational of a head or a face of an object.

It is another object of the invention to provide such a mold of a deformable material and the decorative peripheral border helps stiffen the mold at the opening into the mold.

A further object is to have such a mold which releases the baked cupcake or muffin or molded food item.

### BRIEF DESCRIPTION OF THE DRAWING(S)

The foregoing and other objects will be apparent from the following description of preferred embodiments shown in the accompanied drawings in which:

FIG. 1 is a perspective view from the top or front side of a cupcake or muffin mold showing the invention applied to one measurement of a cupcake mold;

FIG. 2 is a top view thereof;

FIG. 3 is a side view thereof;

FIG. 4 is a cross-sectional view thereof across the centerline of the mold at 4-4 in FIG. 2;

FIG. 5 is a bottom view thereof;

FIG. 6 shows the mold containing batter and decoration;

FIG. 7 is a perspective view of a second embodiment of a cupcake or muffin mold;

FIG. 8 is a top view thereof;

FIG. 9 is a side view thereof;

FIG. 10 is a cross-sectional view thereof across the centerline of the mold at 10-10 in FIG. 8; and

FIG. 11 is a bottom view thereof.

### DESCRIPTION OF PREFERRED EMBODIMENTS

A cupcake or muffin mold or a mold for other moldable food items are hereinafter referred to as a cupcake mold which represents one form or use of the invention.

A cupcake mold 10 includes a cup portion 12 with an open top end 14 and a closed bottom 16. It has a circular peripheral wall 18 with crenellations 19 optionally provided.

The periphery 20 of the cup 12 at the open end 14 has a decorative peripheral border 22 surrounding and around its entire periphery, preferably without any spaces along the decorative peripheral border. The decorative peripheral border projects out from the periphery 20 of the cup and provides stiffening for the upper open end 14 of the cup so that it retains or restores to an original shape, here shown as circular, even when the cup may be manipulated and held for initial loading of the batter and for later removal of a baked cupcake from the mold.

In a preferred form, the mold 10 and its decorative peripheral border 22 is a one-piece mold. It is preferably comprised of or at least coated with a release material as described above. It is preferably comprised of silicone rubber or other release material that can be molded into a desired shape and can be made of a desired color. Silicone rubber is capable of being molded, can withstand the heat of baking or freezing in a refrigerator, has excellent release properties so that batter in the mold, and a baked cupcake or the like or a chilled moldable food item in the mold cup will not stick to the material of the mold or of the decorative peripheral border around the mold and the baked cupcake and food is released from the mold.

In order to make the mold and its intended use more attractive to users who may be interested in decorative cupcake molds or who may want to decorate a cupcake before it is baked, the decorative peripheral border 22 around the periphery of the mold represents a portion of a head or a face that surrounds typically the entire periphery of the face or the mold and so defines the border of a head or face area. There may be short or arcuate areas of the periphery where the additional ornamentation at the periphery of the mold is lacking for aesthetic reasons. But, either the entire periphery of the mold or nearly the entire periphery is surrounded by the decoration. Numerous embodiments of ornamentation may be selected for the border, each suggesting a selected type of head or face. The decorative peripheral border surrounding the cup open end appears as a representation of a surrounding area of a face or head. The entire open end 14 into the cup 12 and the decorative peripheral border 22 around it define a single head or face, not a body with several parts of anatomy projecting from it, as in prior art.

To stiffen the decorative peripheral border 22, it may be thickened or may have a rib 24 around its periphery and a rib 26 radiating out from the periphery 18 of the cup 12 to the periphery 24 of the decoration 22.

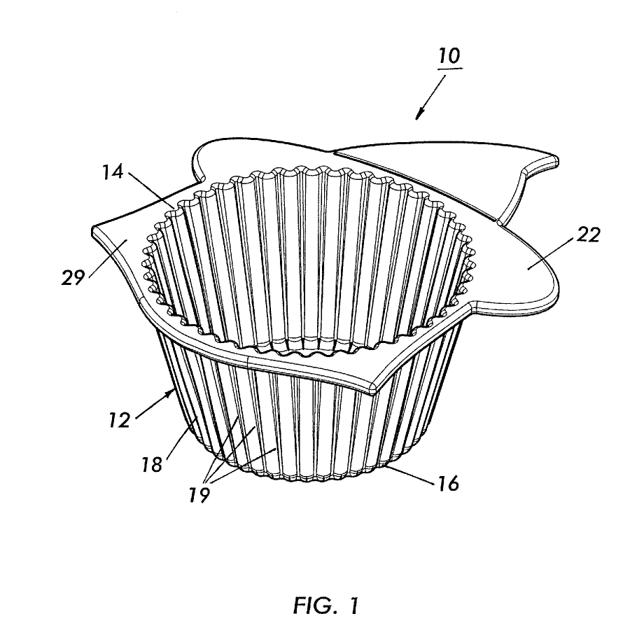

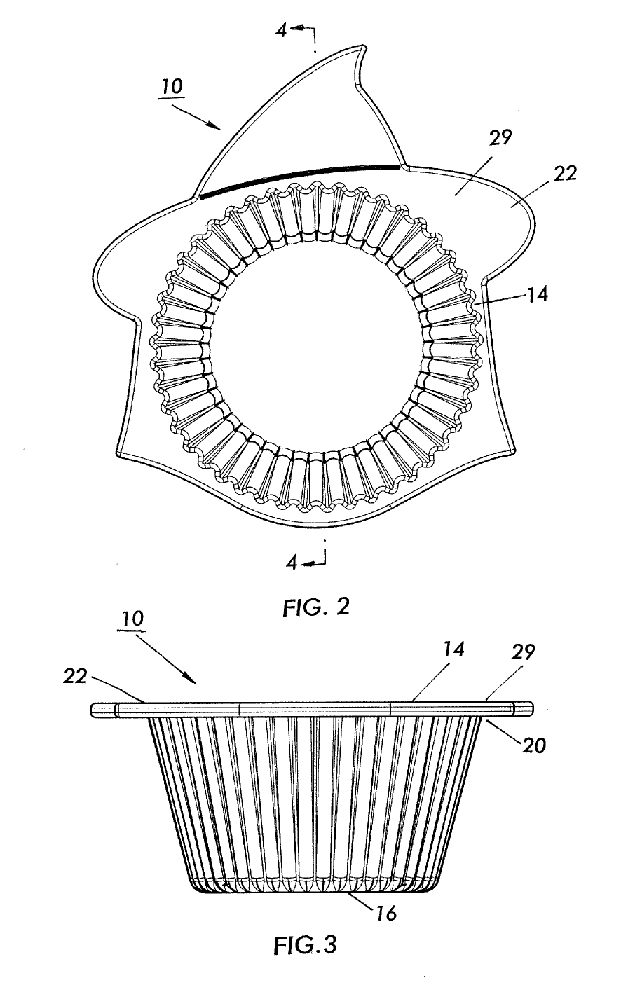

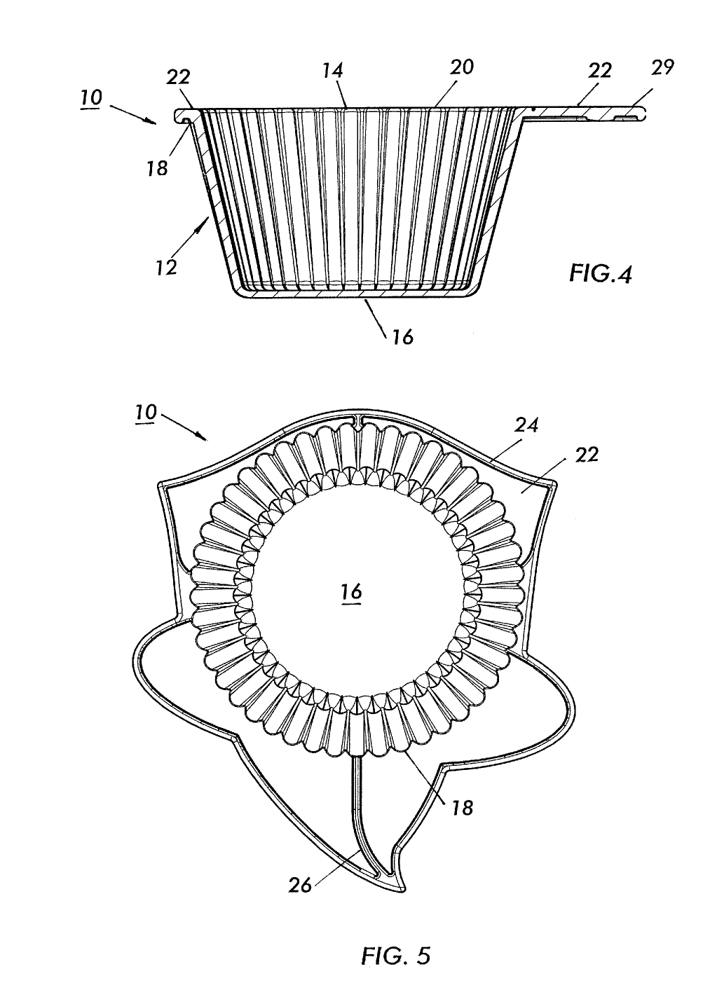

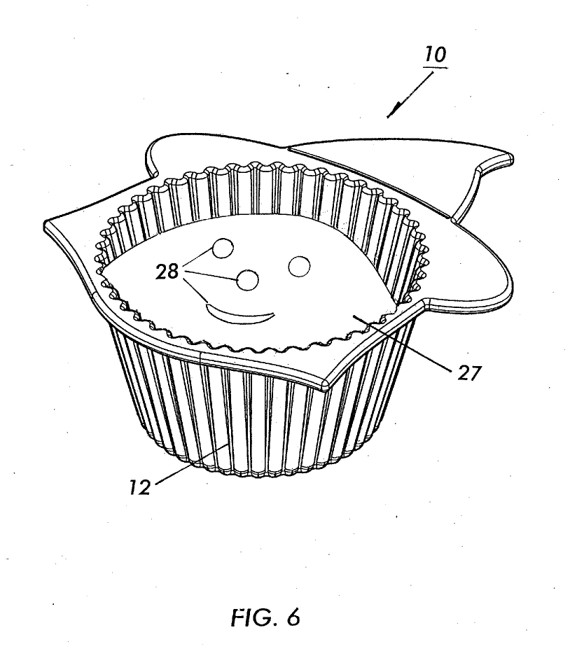

Various examples of heads or faces are illustrated in drawing Figures. In the first embodiment of FIGS. 1-5, for example, the decorative peripheral border 22 together with the head opening of the open end 14 of the cup suggests a witch, and the face in the opening would be that of a witch.

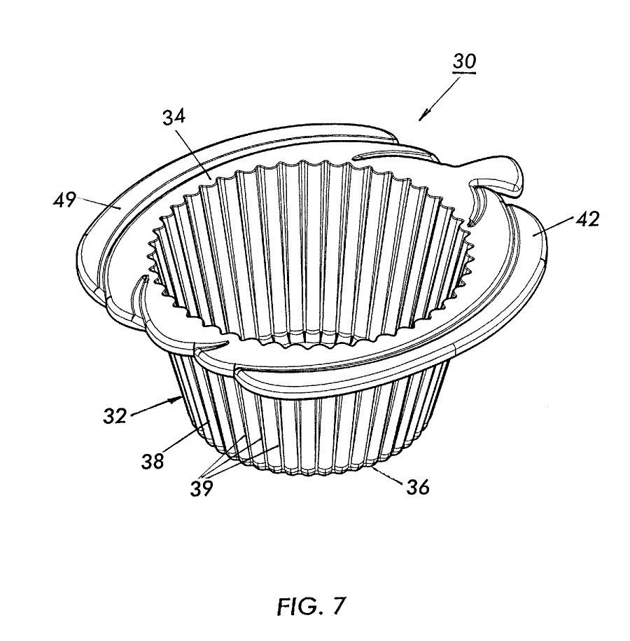

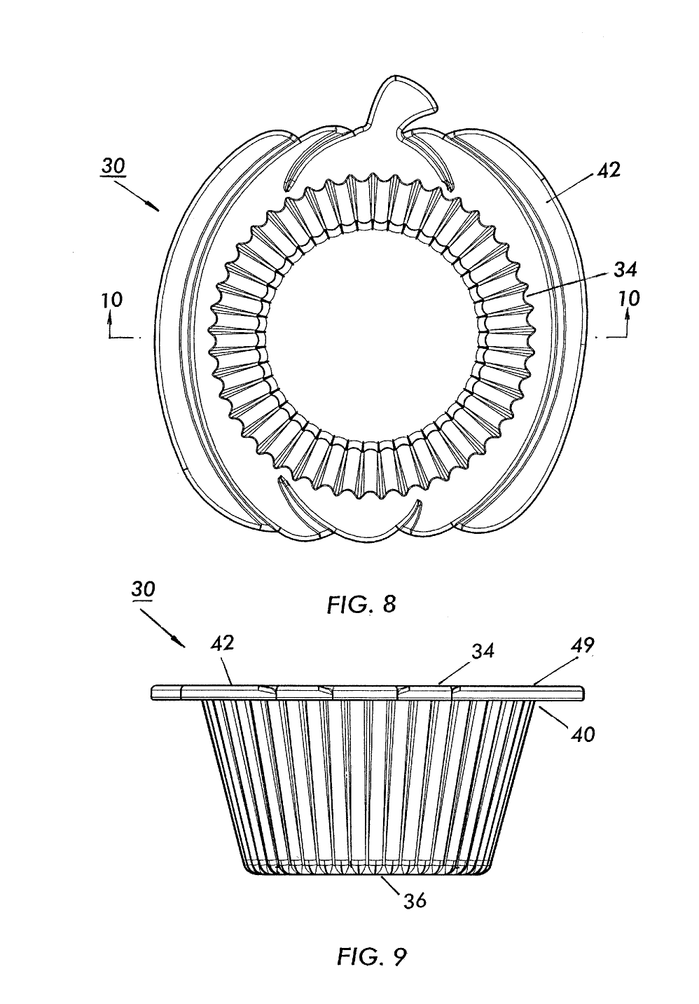

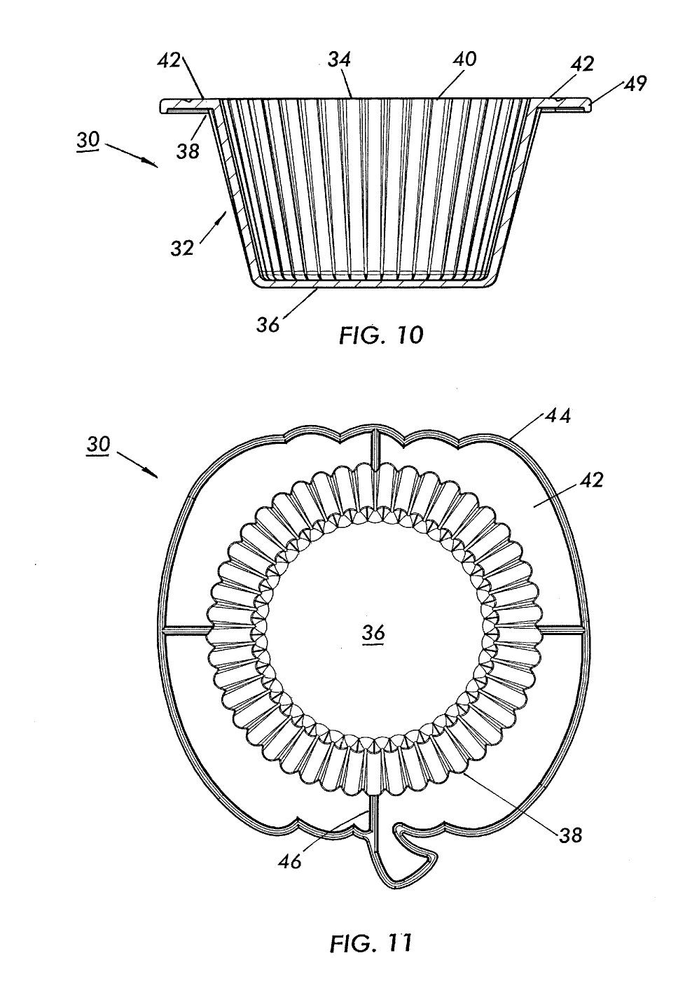

Another decorative peripheral border embodiment in FIGS. 7-11 suggests a pumpkin. Elements of this second embodiment correspond to the first embodiment and are identified by replace numbers raised by 20. For Halloween in the United States, the pumpkin shaped cupcake mold 30 has a face opening 34, as is true with a Jack-O-Lantern, which is a typical Halloween decoration. Other design embodiments may include faces of animals or of people costumed for particular events like weddings, or holidays, such as Christmas or Easter. The variety of different peripheral border ornamentations around heads or faces is limited by the imagination of persons creating heads or faces for a cupcake mold which is fully surrounded by the representation that suggest the head or face.

It is particularly useful for the decorative peripheral border and the cup opening to together define a head or face. Designs of heads or of faces in heads are interesting and attractive areas for creative decoration, as also applies to many toys that have provision for decorating a face. This can make the cupcake mold particularly attractive to children who can decorate the batter placed in the cup opening. For example, as shown in FIG. 6 the batter 27 for creating the cupcake, or the like, may be placed in the cup 12 and then a person, such as a child, may decorate the batter in the mold with representations of facial features 28, such as eyes, nose and mouth made of any selected relevant material, such as confection that would be used on or with a cupcake. The child could feel part of the cupcake creation process. The batter decoration would remain with the cupcake, or the like, after the cupcake is baked and removed from the cupcake mold.

When a cupcake or muffin is baked from batter placed into a mold, as the batter is baked, it expands out of the mold and defines a top or a cap that spreads out slightly over the peripheral border of the cupcake mold. The decorative peripheral border is generally flat on its top side 29 so that the underside of the cap region of the cupcake or muffin will form in a normal way on top of the border around the mold. The border 22 around the cup of the mold may have profiling, grooves, or ridges which are neither tall nor deep and so do not interfere with the spreading of the batter as it is baked or with the shape of the eventual cupcake or mold. The release material of the mold, which material is included in the peripheral border, permits separation of the cupcake or muffin from the mold including separation from the decorative peripheral border around the open end of the mold.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A mold for cupcakes, muffins, moldable food, or the like, comprising:
a cup for receiving batter to be baked or moldable food, the cup having an open end defined by a periphery of the open end;
a peripheral border around the periphery of the open end, the border extends out from the periphery of the mold open end and provides a support for baked batter or for a part of the food that defines a top region of the cupcake, muffin, food, or the like;
the peripheral border completely surrounds the open end and the peripheral border defines an integral shape with the mold to itself and the border is configured and shaped to suggest a periphery of a head or face, and the head or face is suggested by the open end of the mold.

2. The mold of claim 1, comprised of a release material capable of releasing the baked cupcake, muffin, food, or the like and batter for the cupcake, muffin, food, or the like from the mold.

3. The mold of claim 2, wherein the mold is of silicone rubber.

4. The mold of claim 3, wherein the border around the mold is representational of a peripheral region around a head or face.

5. The mold of claim 4, wherein the border is representational of a head of a person.

6. The mold of claim 4, wherein the border is representational of a head of an animal.

7. The mold of claim 8, wherein the border is representational of an object that is neither human nor animal but that is sometimes provided with a representation of a head or face.

8. The mold of claim 9, wherein the border is representational of a pumpkin surface.

9. The mold of claim 4, wherein the border is of a color and shape of an object having the head or face.

10. The mold of claim 1, wherein the peripheral border is wider than the cup at the open end and the border provides stiffening for the cup and the mold around the open end.
